(19) United States
(12) Patent Application Publication
(10) Pub. No.: US 2019/0090506 A1
(43) Pub. Date: Mar. 28, 2019

(54) Deer Mineral Supplement

(71) Applicant: Martin Wengerd, Middlefield, OH (US)

(72) Inventor: Martin Wengerd, Middlefield, OH (US)

(21) Appl. No.: 16/115,500

(22) Filed: Aug. 28, 2018

Related U.S. Application Data
(60) Provisional application No. 62/562,407, filed on Sep. 23, 2017.

(51) Int. Cl. A23K 10/30; A23K 20/24; A23K 20/26; A23K 20/174; A23K 20/163; A23K 50/10

(52) U.S. Cl. CPC A23K 10/30; A23K 20/24; A23K 50/10; A23K 20/174; A23K 20/163; A23K 20/26

(57) ABSTRACT

A composition is disclosed: a grain composition for attracting and offering nutrients to deer herds. The composition includes supplemental minerals to attract deer, to help bucks grow bigger antlers, to help does produce large volumes of higher-quality milk. The composition features a sweetener to entice deer into consuming the composition and salt levels lower than those of typical similar compositions. The composition allows deer to consume vital minerals that they need at certain times of the year when weather or environmental conditions prevent plants from providing these nutrients. The present invention offers a way for hunters to feed and attract deer for future hunting.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of wildlife mineral supplements and more specifically relates to deer supplements.

### 2. Description of Related Art

Deer consume plants in order to obtain vital minerals for proper growth. With proper mineral consumption, bucks will grow larger antlers and doe will produce more, better-quality milk. Deer herds may become unhealthy if they cannot consume plants during certain times of the year. A suitable solution is desired.

U.S. Pat. No. 8,309,146 to Roger Rudd relates to a deer attractant and nutrient. The described deer attractant and nutrient includes feed comprising rice hulls; calcium carbonate; manganese; copper sulfate; zinc sulfate; trace amounts of cobalt carbonate; EDDI; mono DICAL; selenium; and power sweet. Because of the balanced nutritional components of the deer attractant and nutrient, the product is said to enhance overall deer growth including antler growth in bucks. The deer attractant and nutrient is also said to act as a deer attractant, causing the deer to move toward a supply of the attractant.

### BRIEF SUMMARY OF THE INVENTION

In view of the foregoing disadvantages inherent in the known wildlife mineral supplement art, the present disclosure provides a novel deer mineral supplement. The general purpose of the present disclosure, which will be described subsequently in greater detail, is to provide a composition for attracting and offering nutrients to deer herds. Some versions contained grain; some do not. The compositions include supplemental minerals configured to help bucks grow bigger antlers, to help does produce more milk, and to attract deer. The compositions feature a sweetener to entice deer into consuming the composition, and the compositions have lower salt levels than traditional compositions used for similar purposes. The compositions provide deer with vital minerals that they need at certain times of the year when weather or environmental conditions prevent plants from providing those nutrients. The present invention offers a way for hunters to feed and attract deer for future hunting.

A composition is disclosed. The composition includes minerals; monocalcium phosphate; vitamins; and sugars. And in some versions, the compositions include an additional base.

A method of using the composition is also disclosed. The method of using the composition may comprise the steps of providing a composition as described in this document and establishing a mineral site in an area inhabited by animals of the family Cervidae.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a deer mineral supplement, constructed and operative according to the teachings of the present disclosure.

FIG. 1 is a perspective view of animals of family Cervidae.

FIG. 2 is a perspective view of a container and the material of the composition during an ‘in-use’ condition, according to an embodiment of the disclosure.

FIG. 3 is a magnified view of the material of a composition according to an embodiment of the present disclosure.

FIG. 4 is a flow diagram illustrating a method of use for the composition, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a wildlife mineral supplement and more particularly to a deer mineral supplement as used to improve the deer supplement.

Generally, the composition promotes optimal growth and overall health of a deer herd. The compositions comprise trace mineral salts; monocalcium phosphate (BIOFOS brand The Mosaic Company); vitamins A, D, E; and brown sugar. The mixtures can increase deer herds, supporting bucks to grow larger antlers and supporting does to produce more milk. The composition contains reduced levels of salt compared to common feed and attractant products. The sugar entices deer into consuming the healthier composition, ensuring optimal health and growth.

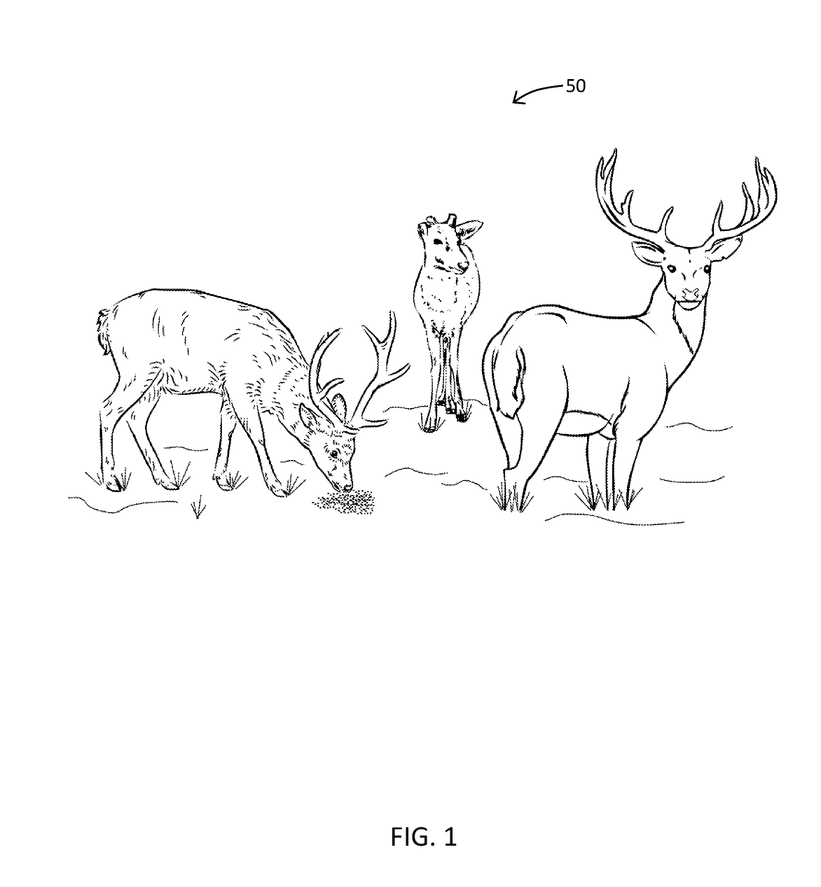

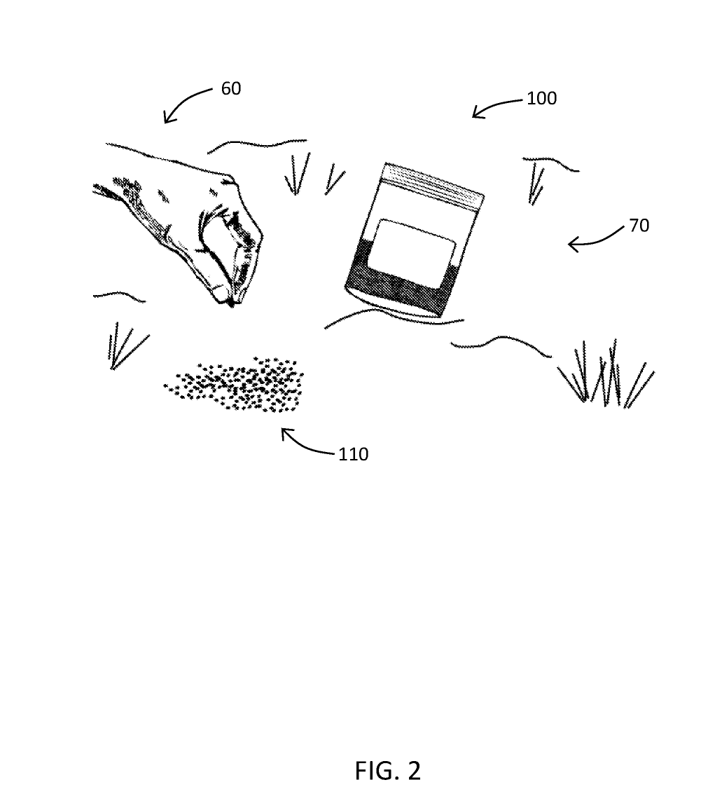

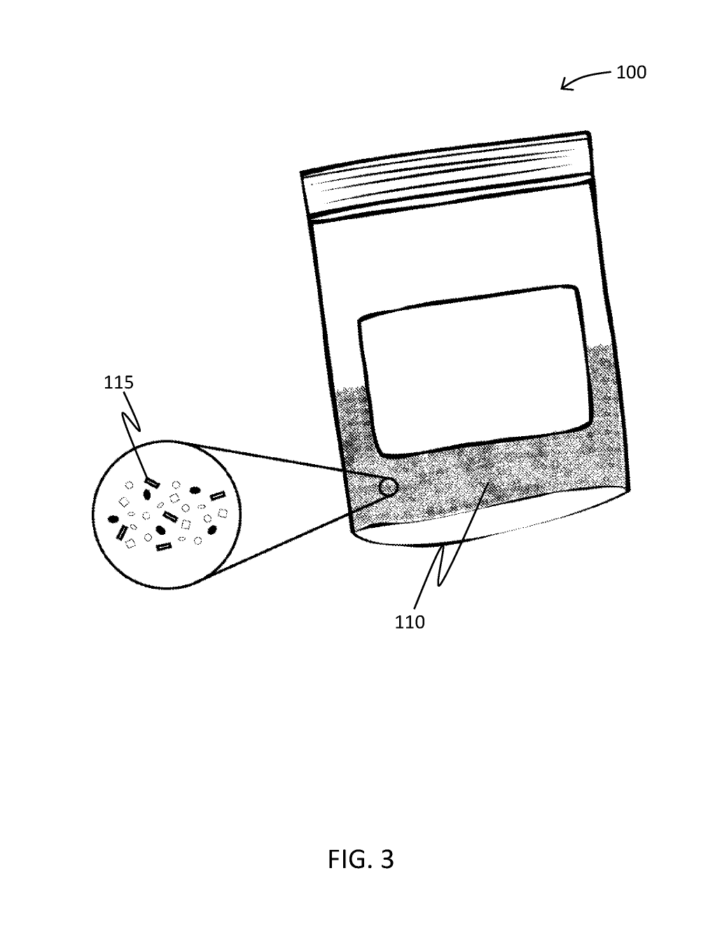

Referring now more specifically to the drawings by numerals of reference, FIG. 1 shows a view of animals 50 of the family Cervidae, such as deer. FIGS. 2-3 show various views of a container 100 for the composition. FIG. 2 shows a container 100 for the material 110 of the composition during an ‘in-use’ condition by a user 60, according to an embodiment of the present disclosure. FIG. 2 shows user 60 establishing a mineral site 70. The composition may include a base, minerals, monocalcium phosphate, vitamins, and sugars, and be formulated to attract animals from the family Cervidae 50, formulated to supply minerals for bone and antler growth, and formulated to support greater, higher-quality milk production. In some versions, the base comprises grains, such as oats, soybeans, tricale, serial rye, grain sorghum, or wheat or combinations of these grains. In some embodiments, the minerals are trace minerals.

In some embodiments, the trace minerals are salts of magnesium, potassium, barium, iron, aluminum, zinc, strontium, or manganese or combination of these salts. In these or other embodiments, vitamins are vitamin A, vitamin D, or vitamin E, or combinations of these vitamins. In these or other embodiments, the sugars or sweeteners are brown sugars, molasseses, refined or semi-refined sugars mixed with molasseses, and maple syrups. In some embodiments addition of the sweetener entices some animals 50 to prefer invention compositions over similar mineral supplements or attractants that do not contain sweeteners. In some embodiments, brown sugar is used as the predominant sweetener including in some embodiments with compositions having grain and compositions lacking grain.

FIG. 3 shows a magnified view of the material 110 of a composition according to an embodiment of the present disclosure. Illustrated here is a class of embodiments in which the material of the composition exists in granules 115.

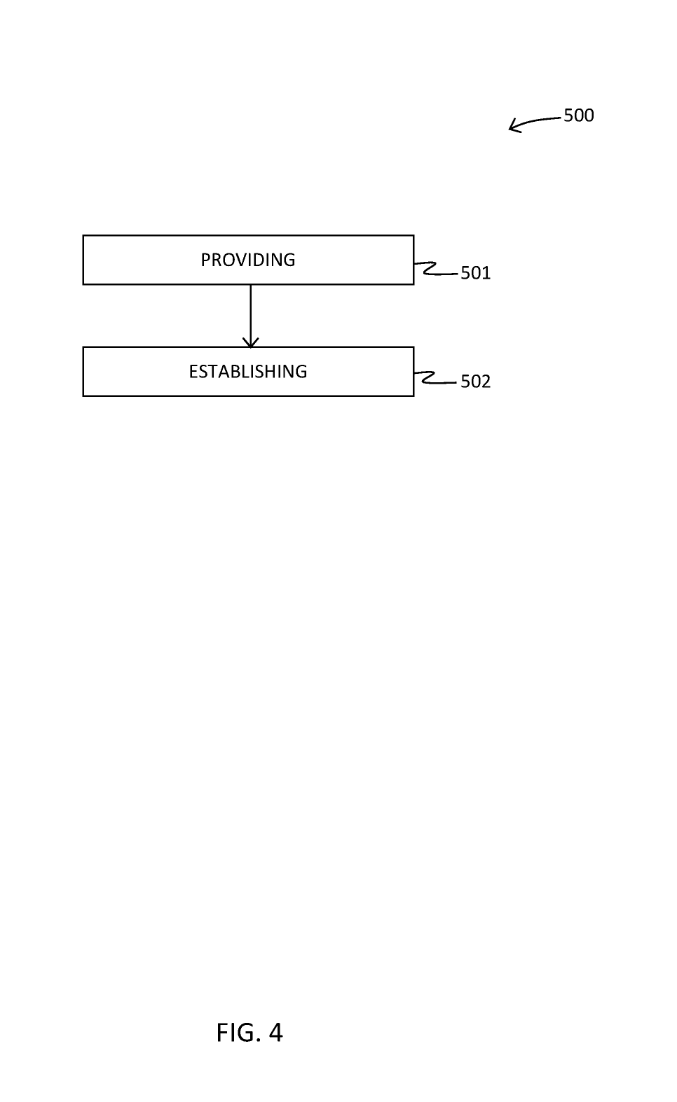

FIG. 4 is a flow diagram illustrating a method according to an embodiment of the present disclosure. As illustrated, the method may include the steps of providing 501 any of the compositions disclosed above and establishing 502 a mineral site 70 in an area inhabited by animals 50 of the family Cervidae.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A composition comprising minerals; monocalcium phosphate; vitamins; and sugars.

2. The composition of claim 1 wherein the composition is formulated to attract animals from the family Cervidae.

3. The composition of claim 2 wherein the composition is formulated to supply minerals for bone and antler growth.

4. The composition of claim 3 further comprising a grain base.

5. The composition of claim 4 wherein the grains are any one or any combination of oats, soybeans, tricale, serial rye, grain sorghum, or wheat.

6. The composition of claim 5 wherein the minerals are trace minerals.

7. The composition of claim 6 wherein the trace minerals are any one or any combination of salts of magnesium, potassium, barium, iron, aluminum, zinc, strontium, and manganese.

8. The composition of claim 7 wherein the vitamins are any one or any combination of vitamin A, vitamin D, and vitamin E.

9. The composition of claim 8 wherein the sugars are any one or any combination of brown sugars, molasseses, refined or semi-refined sugars mixed with molasseses, and maple syrups.

10. The composition of claim 9 wherein the sugars are brown sugars.

11. The composition of claim 10 wherein the composition is formulated to support more, higher-quality milk production.

12. The composition of claim 3 wherein the base comprises a mineral supplement.

13. The composition of claim 12 wherein the minerals are trace minerals.

14. The composition of claim 13 wherein the trace minerals are any one or any combination of salts of magnesium, potassium, barium, iron, aluminum, zinc, strontium, and manganese.

15. The composition of claim 14 wherein the vitamins are any one or any combination of vitamin A, vitamin D, and vitamin E.

16. The composition of claim 15 wherein the sugars are any one or any combination of brown sugars, molasseses, refined or semi-refined sugars mixed with molasseses, and maple syrups.

17. The composition of claim 16 wherein the sugars are brown sugars.

18. The composition of claim 17 wherein the composition is formulated to support more, higher-quality milk production.

19. A composition comprising:
a base selected from
grains that are any one or any combination of oats, soybeans, tricale, serial rye, grain sorghum, or wheat; and, alternatively,
trace minerals that are any one or any combination of salts of magnesium, potassium, barium, iron, aluminum, zinc, strontium, and manganese;
monocalcium phosphate;
any one or any combination of vitamin A, vitamin D, and vitamin E; and
sugars that are any one or any combination of brown sugars, molasses, refined or semi-refined sugars mixed with molasses, and maple syrups,
wherein the composition is formulated to
attract animals from the family Cervidae,
supply minerals for bone and antler growth, and
support more, higher quality milk production.

20. A method comprising providing the composition of claim 19 and establishing a mineral site in an area inhabited by animals of the family Cervidae.
